(19) United States
(12) Patent Application Publication
(10) Pub. No.: US 2024/0375265 A1
(43) Pub. Date: Nov. 14, 2024

(54) Illuminated Mechanic's Creeper Device

(71) Applicant: James Valencia, Santa Fe, NM (US)

(72) Inventor: James Valencia, Santa Fe, NM (US)

(21) Appl. No.: 18/363,855

(22) Filed: Aug. 2, 2023

Related U.S. Application Data
(60) Provisional application No. 63/500,801, filed on May 8, 2023.

(51) Int. Cl. B25H 5/00; F21V 33/00

(52) U.S. Cl. CPC B25H 5/00; F21V 33/008; F21S 9/02; F21V 21/32

(57) ABSTRACT

An illuminated mechanic's creeper device is provided. The device is comprised of a mechanic's creeper comprised of at least one light that can be manually repositioned or repositioned via a motor and control to illuminate a desired area on a vehicle's underside in a hands-free manner. A headrest of the device can also be raised manually or via a motor to provide increased comfort when a user has to raise their head/neck to view a portion of the vehicle's underside.

### CROSS-REFERENCE TO RELATED APPLICATION

The present application claims priority to, and the benefit of, U.S. Provisional Application No. 63/500,801, which was filed on May 8, 2023, and is incorporated herein by reference in its entirety.

### FIELD OF THE INVENTION

The present invention relates generally to the field of mechanic's creepers. More specifically, the present invention relates to an illuminated mechanic's creeper device that provides a light that can be positioned to illuminate the underside of a vehicle in a hands-free manner. In addition, the device is comprised of an adjustable headrest to increase neck comfort. Accordingly, the present disclosure makes specific reference thereto. Nonetheless, it is to be appreciated that aspects of the present invention are also equally applicable to other like applications, devices, and methods of manufacture.

### BACKGROUND

When working underneath a vehicle, individuals will typically use a mechanic's creeper to access the undercarriage easily and safely. However, light is limited underneath a vehicle which forces the individual to hold a flashlight in one hand. This is undesirable, as it only leaves one hand free for working. Alternatively, an individual can wear a hand or headlamp. However, these alternatives can also be inefficient and may still be unable to illuminate a particular area to work. In addition, existing mechanic's creepers may not support a user's neck adequately, requiring that the user raise and hold their neck above the creeper for a prolonged period of time, which can lead to injury.

Therefore, there exists a long-felt need in the art for an improved device for illumination of the underside of a vehicle. There also exists a long-felt need in the art for an illuminated mechanic's creeper device that can illuminate the underside of a vehicle while working on said vehicle. More specifically, there exists a long-felt need in the art for an illuminated mechanic's creeper device that can illuminate the underside of a vehicle while working on said vehicle in a hands-free manner. Further, there exists a long-felt need in the art for an illuminated mechanic's creeper device that can illuminate the underside of a vehicle while working on said vehicle in a hands-free manner and wherein the device increases neck comfort of a user during use.

The subject matter disclosed and claimed herein, in one embodiment thereof, comprises an illuminated mechanic's creeper device. The device is comprised of a mechanic's creeper comprised of at least one light and at least one headrest. The light can be manually repositioned or repositioned via a motor and control to illuminate a desired area on a vehicle's underside in a hands-free manner. The headrest can also be raised manually or via a motor to provide increased comfort when a user has to raise their head/neck to view a portion of the vehicle's underside.

In this manner, the illuminated mechanic's creeper device of the present invention accomplishes all the foregoing objectives and provides an improved device for illumination of the underside of a vehicle. More specifically, the device provides an illuminated mechanic's creeper device that can illuminate the underside of a vehicle while working on said vehicle. More specifically, the device can illuminate the underside of a vehicle while working on said vehicle in a hands-free manner. Further, the device increases neck comfort of a user during use via the adjustable headrest.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an illuminated mechanic's creeper device. The device is comprised of an improved mechanic's creeper with at least one light that can be repositioned by the user during use to eliminate the need for a user to hold a flashlight separately while using a creeper under a vehicle to illuminate the underside of the vehicle.

The device is comprised of a body that is generally rectangular in shape but may be any shape such that a user can comfortably lay within the body on their back. The body is comprised of a first recessed area that receives the back of the user. The body is also comprised of at least two second recessed areas which receive the arms/shoulders of the user while laying on their back. In one embodiment, any portion of the body may be comprised of at least one padding for comfort.

To allow the body to easily move underneath a vehicle, the body is comprised of at least one wheel that can preferably rotate 360 degrees around at least one vertical wheel axle. The wheel may be a locking wheel in one embodiment to allow a user to fix the position of the device underneath a vehicle.

The body is also comprised of at least one headrest. In one embodiment, the headrest can raise above the body to improve the head/neck position of a user while laying. In this embodiment, the headrest can be locked into a raised position via at least one locking member. The headrest may raise/lower manually via any mechanism such as, but not limited to, a crank, scissor arms, a hydraulic arm, etc. Alternatively, the headrest can be raised/lowered via at least one electric motor using at least one control.

Any portion of the body and/or headrest is also comprised of at least one light. In one embodiment, the light is positioned within the body. In this embodiment, the light may be manually tilted/rotated 360 degrees via at least one axle. In another embodiment, the light may be rotated 360 degrees via at least one motor controlled by the controls. In a further embodiment, the light extends from the body via at least one flexible arm.

The controls may be positioned on the body in one embodiment. In another embodiment, the controls may be comprised of a removable control (i.e., a handheld control) that can be removed from the body and held by the user. The controls may be in the form of at least one button, at least one directional pad, at least one lever, at least one toggle switch, etc., or any other control structure known in the art. The controls allow a user to position the light and the height of the headrest in an embodiment where the light and headrest are both comprised of at least one motor.

The present invention is also comprised of a method of using the device. First, a device is provided comprised of a body with at least one wheel, at least one headrest, and at least one light. Then, a user lays on the body and rolls the body underneath a vehicle. Then, a user positions (i.e., tilts or rotates) the light manually to illuminate a specific portion of a vehicle's underside. In an additional embodiment, a user can position (i.e., move) a light attached to the body via at least one flexible arm to illuminate a specific portion of a vehicle's underside. A user can then increase or decrease the brightness of the light via at least one button or control. Then, a user can also manually adjust the headrest to a raised position and secure the headrest in said position via at least one locking member of the headrest.

The present invention is also comprised of a second method of using the device. First, a device is provided comprised of a body with at least one wheel, at least one headrest comprised of at least one motor, and at least one light comprised of at least one motor. Then, a user lays on the body and rolls the body underneath a vehicle. Next, a user positions (i.e., tilts or rotates) the light using the control to control the motor of the light to illuminate a specific portion of a vehicle's underside. In an additional embodiment, a user can position (i.e., move) a light attached to the body via at least one flexible arm to illuminate a specific portion of a vehicle's underside. A user can then increase or decrease the brightness of the light via at least one button or control. Then, a user can adjust the headrest to a raised position via the motor by using the control.

Accordingly, the illuminated mechanic's creeper device of the present invention is particularly advantageous as it provides an improved device for illumination of the underside of a vehicle. More specifically, the device provides an illuminated mechanic's creeper device that can illuminate the underside of a vehicle while working on said vehicle. More specifically, the device can illuminate the underside of a vehicle while working on said vehicle in a hands-free manner. Further, the device increases neck comfort of a user during use via the adjustable headrest. In this manner, the illuminated mechanic's creeper device overcomes the limitations of existing methods and devices used while working underneath a vehicle that are known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an illuminated mechanic's creeper device of the present invention in accordance with the disclosed architecture;

FIG. 2 illustrates an enhanced perspective view of one potential embodiment of an illuminated mechanic's creeper device of the present invention in accordance with the disclosed architecture;

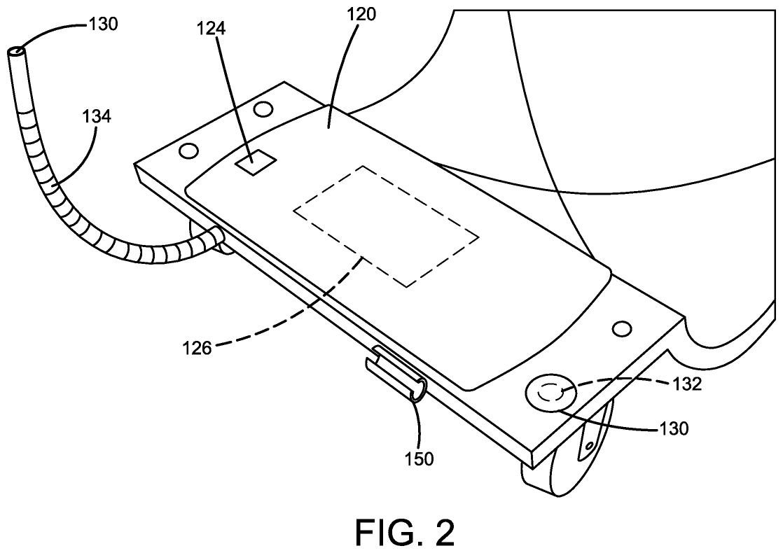

FIG. 3 illustrates an enhanced perspective view of one potential embodiment of an illuminated mechanic's creeper device of the present invention in accordance with the disclosed architecture;

FIG. 4 illustrates a perspective view of one potential embodiment of an illuminated mechanic's creeper device of the present invention while being used by a user underneath a vehicle in accordance with the disclosed architecture;

FIG. 5 illustrates a flowchart of a method of using one potential embodiment of an illuminated mechanic's creeper device of the present invention in accordance with the disclosed architecture; and

FIG. 6 illustrates a flowchart of a method of using one potential embodiment of an illuminated mechanic's creeper device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved device for illumination of the underside of a vehicle. There also exists a long-felt need in the art for an illuminated mechanic's creeper device that can illuminate the underside of a vehicle while working on said vehicle. More specifically, there exists a long-felt need in the art for an illuminated mechanic's creeper device that can illuminate the underside of a vehicle while working on said vehicle in a hands-free manner. Further, there exists a long-felt need in the art for an illuminated mechanic's creeper device that can illuminate the underside of a vehicle while working on said vehicle in a hands-free manner and wherein the device increases neck comfort of a user during use.

The present invention, in one exemplary embodiment, is comprised of an illuminated mechanic's creeper device. The device is comprised of an improved mechanic's creeper with at least one light that can be repositioned by the user during use. The light eliminates the need for a user to hold a flashlight separately while using a creeper under a vehicle to illuminate the underside of the vehicle.

The device is comprised of a body that is generally rectangular in shape but may be any shape such that a user can comfortably lay within the body on their back. The body is comprised of a first recessed area that receives the back of the user. The body is also comprised of at least two second recessed areas which receive the arms/shoulders of the user while laying on their back. In one embodiment, any portion of the body may be comprised of at least one padding for comfort.

To allow the body to easily move underneath a vehicle, the body is comprised of at least one wheel. The wheel can preferably rotate 360 degrees around at least one vertical wheel axle. The wheel may be a locking wheel in one embodiment to allow a user to fix the position of the device underneath a vehicle.

The body is also comprised of at least one headrest that may be raised above the body to improve the head/neck position of a user while laying, in one embodiment. In this embodiment, the headrest can be locked into a raised position via at least one locking member. The headrest may raise/lower manually via any mechanism such as, but not limited to, a crank, scissor arms, a hydraulic arm, etc. Alternatively, the headrest can be raised/lowered via at least one electric motor using at least one control.

Any portion of the body and/or headrest is also comprised of at least one light. The light may be positioned within the body and can be manually tilted/rotated 360 degrees via at least one axle. In another embodiment, the light may be rotated 360 degrees via at least one motor controlled by the controls. In a further embodiment, the light extends from the body via at least one flexible arm.

The controls may be positioned on the body in one embodiment. In another embodiment, the controls may be comprised of a removable control (i.e., a handheld control) that can be removed from the body and held by the user. The controls may be in the form of at least one button, at least one directional pad, at least one lever, at least one toggle switch, etc., or any other control structure known in the art. The controls allow a user to position the light and the height of the headrest in an embodiment where the light and headrest are both comprised of at least one motor.

The present invention is also comprised of a method of using the device. First, a device is provided comprised of a body with at least one wheel, at least one headrest, and at least one light. Then, a user lays on the body and rolls the body underneath a vehicle. Then, a user positions (i.e., tilts or rotates) the light manually to illuminate a specific portion of a vehicle's underside. In an additional embodiment, a user can position (i.e., move) a light attached to the body via at least one flexible arm to illuminate a specific portion of a vehicle's underside. A user can then increase or decrease the brightness of the light via at least one button or control. Then, a user can also manually adjust the headrest to a raised position and secure the headrest in said position via at least one locking member of the headrest.

The present invention is also comprised of a second method of using the device. First, a device is provided comprised of a body with at least one wheel, at least one headrest comprised of at least one motor, and at least one light comprised of at least one motor. Then, a user lays on the body and rolls the body underneath a vehicle. Next, a user positions (i.e., tilts or rotates) the light using the control to control the motor of the light to illuminate a specific portion of a vehicle's underside. In an additional embodiment, a user can position (i.e., move) a light attached to the body via at least one flexible arm to illuminate a specific portion of a vehicle's underside. A user can then increase or decrease the brightness of the light via at least one button or control. Then, a user can adjust the headrest to a raised position via the motor by using the control.

Accordingly, the illuminated mechanic's creeper device of the present invention is particularly advantageous as it provides an improved device for illumination of the underside of a vehicle. More specifically, the device provides an illuminated mechanic's creeper device that can illuminate the underside of a vehicle while working on said vehicle. More specifically, the device can illuminate the underside of a vehicle while working on said vehicle in a hands-free manner. Further, the device increases neck comfort of a user during use via the adjustable headrest. In this manner, the illuminated mechanic's creeper device overcomes the limitations of existing methods and devices used while working underneath a vehicle that are known in the art.

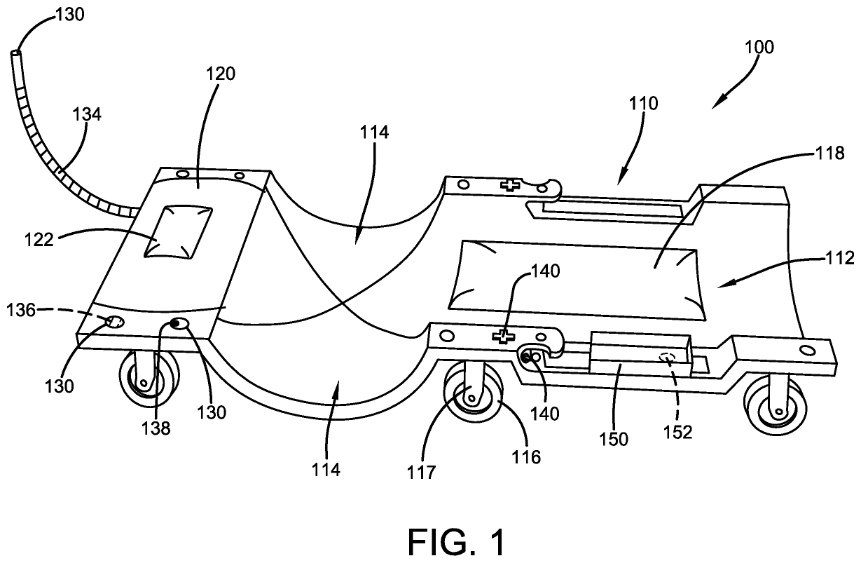

Referring initially to the drawings, FIG. 1 illustrates a perspective view of one potential embodiment of an illuminated mechanic's creeper device 100 of the present invention in accordance with the disclosed architecture. The device 100 is comprised of an improved mechanic's creeper with at least one light 130 that can be repositioned by the user during use. The repositionable light 130 eliminates the need for a user to hold a flashlight separately while using a creeper under a vehicle to illuminate the underside 10 of the vehicle.

The device 100 is comprised of a body 110. The body 110 is preferably made from a lightweight plastic or lightweight metal material that is magnetic. The body 110 is generally rectangular in shape but may be any shape such that a user can comfortably lay within the body 110 on their back.

The body 110 is comprised of a first recessed area 122. The first recessed area 112 receives the back of the user. The body 110 is also comprised of at least two second recessed areas 114 which receive the arms/shoulders of the user while laying on their back. In one embodiment, any portion of the body 110 may be comprised of at least one padding 118 for comfort. The padding 118 may be any padding type known in the art such as, but not limited to, gel, cooling gel, memory foam, foam, etc.

To allow the body 110 to easily move underneath a vehicle, the body 110 is comprised of at least one wheel 116. The wheel 116 may be any type and style of wheel known in the art. The wheel 116 can preferably rotate 360 degrees around at least one vertical wheel axle 117. The wheel 116 may be a locking wheel in one embodiment to allow a user to fix the position of the device 100 underneath a vehicle.

The body 110 is also comprised of at least one headrest 120. The headrest 120 may be comprised of at least one padded section 122. The padding 122 may be any padding type known in the art such as, but not limited to, gel, cooling gel, memory foam, foam, etc. In one embodiment, the headrest 120 can raise above the body 110 to improve the head/neck position of a user while laying. In this embodiment, the headrest 120 can be locked into a raised position via at least one locking member 124 such as, but not limited to, a button, a lever, a latch, etc. The headrest 120 may raise/lower manually via any mechanism such as, but not limited to, a crank, scissor arms, a hydraulic arm, etc. Alternatively, the headrest 120 can be raised/lowered via at least one electric motor 126 using at least one control 140.

Any portion of the body 110 and/or headrest 120 is also comprised of at least one light 130. The light 130 is preferably an LED light that may illuminate any color. The light 130 preferably has a plurality of brightness levels that can be selected via the control 140 and/or at least one button 138 positioned on (or near) the light 130. In one embodiment, the light 130 is positioned within the body 110. In this embodiment, the light 130 may be manually tilted/rotated 360 degrees via at least one axle 136. In another embodiment, the light may be rotated 360 degrees via at least one motor 132 controlled by the controls 140. In a further embodiment, the light 130 extends from the body 110 via at least one flexible arm 134. The arm 134 may be magnetic to receive tools/fasteners. In this manner, a user can position the light 130 to shine on the underside of a vehicle instead of holding a flashlight.

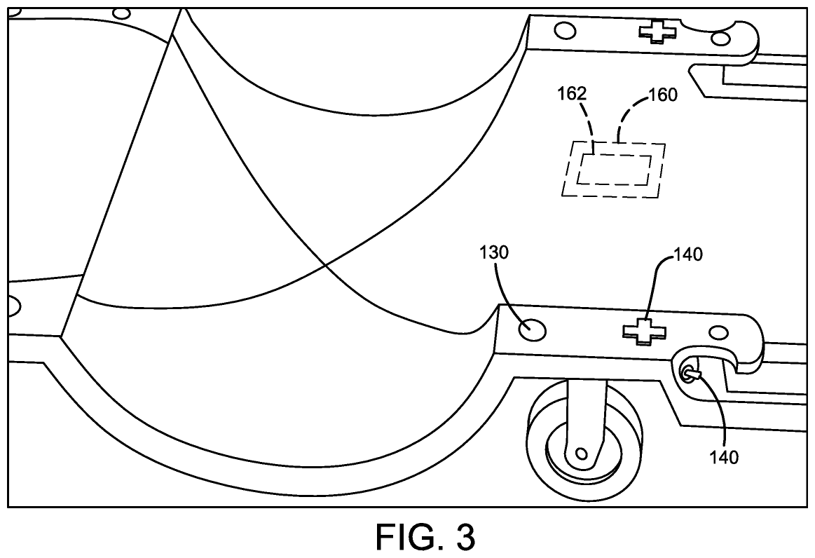

The controls 140 may be positioned on the body 110 in one embodiment, as seen in FIG. 3. In another embodiment, the controls 140 may be comprised of a removable control (i.e., a handheld control) that can be removed from the body 110 and held by the user. The controls 140 may be in the form of at least one button, at least one directional pad, at least one lever, at least one toggle switch, etc., or any other control structure known in the art. The controls 140 allows a user to position the light 130 and the height of the headrest 120 in an embodiment where the light 130 and headrest 120 are both comprised of at least one motor 126,132.

The body 110 may also be comprised of at least one tool tray 150 that can receive tools/fasteners. The tray 150 may be fixedly or removably attached to the body 110 via at least one fastener 152 such as, but not limited to, tongue and groove, magnet, hook, and loop, etc. The tray 150 is preferably magnetic to secure magnetic tools and fasteners. In one embodiment, the tray 150 is comprised of a clip that can receive the handle of a tool.

The light 130 and motors 126,132 are powered by at least one battery 160. The battery 160 is comprised of a removable battery. The battery 160 can be recharged via at least one charging port such as, but not limited to, a USB port or any other battery terminal/contact known in the art.

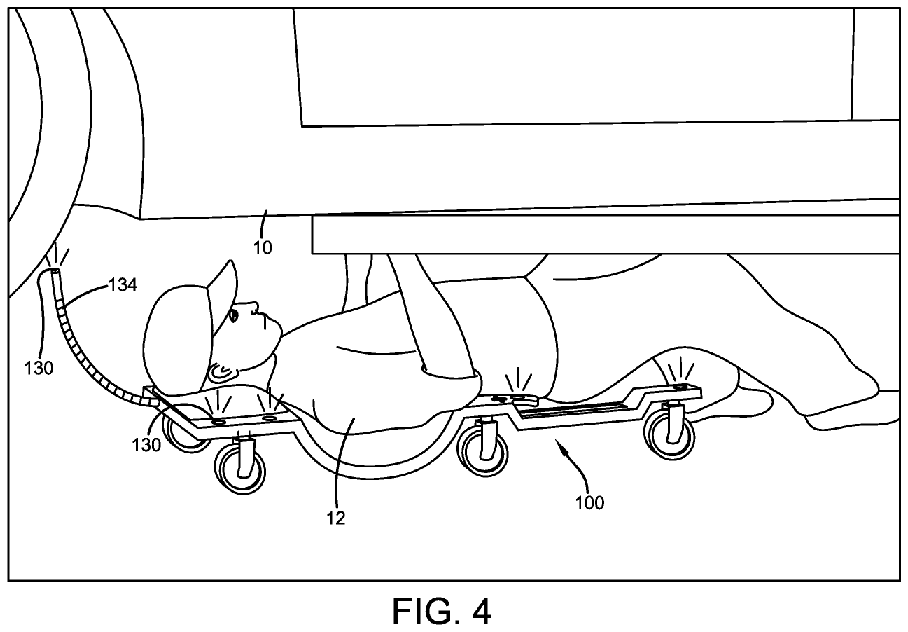

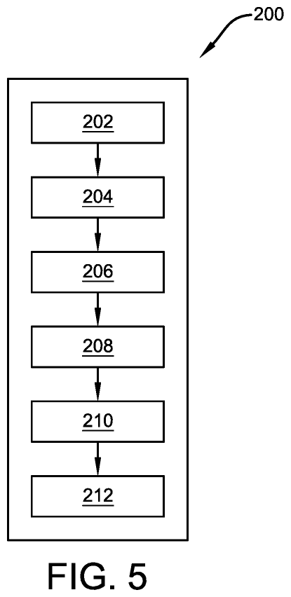

The present invention is also comprised of a method of using 200 the device 100, as seen in FIG. 5. First, a device 100 is provided comprised of a body 110 with at least one wheel 116, at least one headrest 120, and at least one light 130 [Step 202]. Then, a user 12 lays on the body 110 and rolls the body 110 underneath a vehicle, as seen in FIG. 4 [Step 204]. Then, a user 12 positions (i.e., tilts or rotates) the light 130 manually to illuminate a specific portion of a vehicle underside 10 [Step 206]. In an additional embodiment, a user 12 can position (i.e., move) a light 130 attached to the body 110 via at least one flexible arm 134 to illuminate a specific portion of a vehicle underside 10 [Step 208]. A user 12 can then increase or decrease the brightness of the light 130 via at least one button 138 or control 140 [Step 210]. Then, a user 12 can also manually adjust the headrest 120 to a raised position and secure the headrest 120 in said position via at least one locking member 124 of the headrest 120 [Step 212].

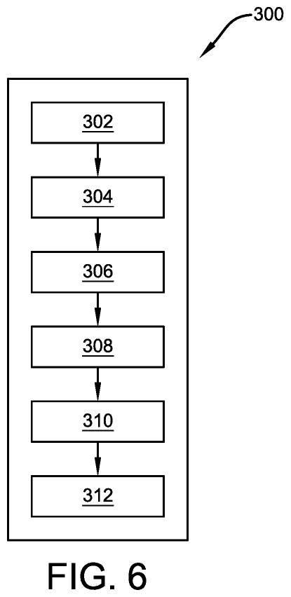

The present invention is also comprised of a method of using 300 the device 100, as seen in FIG. 6. First, a device 100 is provided comprised of a body 110 with at least one wheel 116, at least one headrest 120 comprised of at least one motor 126, and at least one light 130 comprised of at least one motor 132 [Step 302]. Then, a user 12 lays on the body 110 and rolls the body 110 underneath a vehicle, as seen in FIG. 4 [Step 304]. Then, a user 12 positions (i.e., tilts or rotates) the light 130 using the control 140 to control the motor 132 of the light 130 to illuminate a specific portion of a vehicle underside 10 [Step 306]. In an additional embodiment, a user 12 can position (i.e., move) a light 130 attached to the body 110 via at least one flexible arm 134 to illuminate a specific portion of a vehicle underside 10 [Step 308]. A user 12 can then increase or decrease the brightness of the light 130 via at least one button 138 or control 140 [Step 310]. Then, a user 12 can adjust the headrest 120 to a raised position via the motor 126 by using the control 140 [Step 312].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “illuminated mechanic's creeper device” and “device” are interchangeable and refer to the illuminated mechanic's creeper device 100 of the present invention.

Notwithstanding the foregoing, the illuminated mechanic's creeper device 100 of the present invention and its various components can be of any suitable size and configuration as is known in the art without affecting the overall concept of the invention, provided that they accomplish the above-stated objectives. One of ordinary skill in the art will appreciate the size, configuration, and material of the illuminated mechanic's creeper device 100 as shown in the FIGS. are for illustrative purposes only, and that many other sizes and shapes of the illuminated mechanic's creeper device 100 are well within the scope of the present disclosure. Although the dimensions of the illuminated mechanic's creeper device 100 are important design parameters for user convenience, the illuminated mechanic's creeper device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An illuminated mechanic's creeper device comprising:
a body comprised of a first recessed area and a second recessed area;
a headrest positioned on the body;
a first light positioned on the body, the first light comprised of an axle;
a wheel positioned on the body; and
a battery comprised of a charging port.

2. The illuminated mechanic's creeper device of claim 1 further comprised of a flexible arm.

3. The illuminated mechanic's creeper device of claim 2, wherein the flexible arm is comprised of a second light.

4. The illuminated mechanic's creeper device of claim 2, wherein the flexible arm is magnetic.

5. The illuminated mechanic's creeper device of claim 1 further comprised of a tool tray.

6. The illuminated mechanic's creeper device of claim 5, wherein the tool tray is magnetic.

7. The illuminated mechanic's creeper device of claim 1, wherein the light is comprised of a first brightness level and a second brightness level.

8. The illuminated mechanic's creeper device of claim 7, wherein the first brightness level or the second brightness level can be selected by the button.

9. The illuminated mechanic's creeper device of claim 1, wherein the headrest is comprised of a locking mechanism.

10. The illuminated mechanic's creeper device of claim 1, wherein the headrest is comprised of a padding.

11. The illuminated mechanic's creeper device of claim 1, wherein the first recessed area is comprised of a padding.

12. An illuminated mechanic's creeper device comprising:
a body comprised of a first recessed area and a second recessed area;
a headrest positioned on the body, the headrest comprised of a first motor;
a first light positioned on the body, the first light comprised of a second motor;
a wheel positioned on the body;
a control; and
a battery comprised of a charging port.

13. The illuminated mechanic's creeper device of claim 12 further comprised of a flexible arm.

14. The illuminated mechanic's creeper device of claim 13, wherein the flexible arm is comprised of a second light.

15. The illuminated mechanic's creeper device of claim 12, wherein the first motor raises or lowers the headrest.

16. The illuminated mechanic's creeper device of claim 12, wherein the second motor tilts the light.

17. The illuminated mechanic's creeper device of claim 12, wherein the first motor and the second motor are controlled by the control.

18. The illuminated mechanic's creeper device of claim 12, wherein the first motor and the second motor receive power from the battery.

19. A method of using an illuminated mechanic's creeper device, the method comprising the following steps:
providing an illuminated mechanic's creeper device comprised of a body comprised of a wheel, a headrest, and a light;
laying on the body;
rolling the body underneath a vehicle;
repositioning the light underneath the vehicle to illuminate a specific portion of the vehicle; and
raising the position of the headrest.

20. The method of claim 19, wherein the light is attached to a flexible arm, or attached to the body via an axle or a motor.
